(19) United States
(12) Patent Application Publication
(10) Pub. No.: US 2014/0194198 A1
(43) Pub. Date: Jul. 10, 2014

(54) COMPUTER-BASED SYSTEM AND METHOD FOR GAMIFYING RIDE SHARING

(71) Applicant: Ecology & Environment, Inc., Lancaster, NY (US)

(72) Inventors: Anthony Bruce Gale, Hutto, TX (US); David Andrew Mehalick, Tonawanda, NY (US); Jeffrey Scott Lent, Amherst, NY (US); Thomas Edwin Ohnmeiss, Hamburg, NY (US)

(21) Appl. No.: 14/024,090

(22) Filed: Sep. 11, 2013

Related U.S. Application Data
(60) Provisional application No. 61/718,533, filed on Oct. 25, 2012.

(51) Int. Cl. A63F 13/40

(52) U.S. Cl. CPC A63F 13/10
USPC 463/29

(57) ABSTRACT

A computer-based method for gamifying ride sharing, including: storing computer readable instructions in at least one memory element of at least one computer; and executing, using at least one processor for the at least one computer, the computer readable instructions to: accept a first input including a sign-up by a user for a game; accept a second input including information regarding single occupant vehicle trips reduced by the user; assign, according to the information, a position of the user on a virtual board for the game, a ranking of the user in the game and at least one reward to the user; and transmit, for display, a graphical representation of the virtual board including the position of the user.

### CROSS-REFERENCE TO RELATED APPLICATIONS

This application claims priority from U.S. Patent Application No. 61/718,533, filed Oct. 25, 2012, which application is incorporated herein by reference in its entirety.

### TECHNICAL FIELD

The present disclosure relates to a computer-based system and method for gamifying ride sharing. In particular, the gamifying includes a virtual rideshare game board whereby a user's or team's trip location and progress on the game board is primarily powered by how many single occupant vehicle (SOV) trips and/or vehicles mile traveled (VMT) a user or team reduces in the real world.

### SUMMARY

According to aspects illustrated herein, there is provided a computer-based system and method for gamifying ride sharing. The disclosure describes a unique approach to encourage user participation in more environmentally sustainable transportation modes through promoting ridesharing via gamification based web and mobile application based platforms. The invention accomplishes this using virtual rideshare game boards whereby a user's or team's virtual trip location, progress, achievements and their overall status level is powered by how many single occupant vehicle trips (SOVTs) and/or vehicles mile traveled (VMT) a user or team reduces in the real world.

The game board landscapes are theme-aligned and present a visual display of individual and team based virtual journey progress to users. The games incorporate search, discovery, recognition, rewards and fulfillment through the use of points, levels, leaderboards, badges, challenges, quizzes, giveaways, raffles, virtual goods and services purchase opportunities and financial rewards. The games offer users the opportunity to achieve mastery, de-stress, socialize and to have fun. Game participants include both individuals and teams. Teams can be groups of individuals, schools, employers, cities and nations.

The games that a user or team opts to participate in reflects their trip progress on the virtual game boards based on the users' and/or teams' self-reported single occupant vehicle trip reductions (SOVTR) and/or Vehicle Miles Traveled reduced (VMTR) in the physical world through the use of more environmental sustainable travel modes including carpooling, vanpooling, bus, train, light rail, cycling, walking and telecommuting. Specifically, the users' or teams' SOVTR and/or VMTR count as “Commute Point” credits towards their visible progress on the game boards in the virtual world and their overall status levels from participation in multiple games. SOVTRs and/or VMTRs are the primary currency that powers a user's or team's progress along the virtual route as well as their game specific and overall status, level of privileges, recognition, and ability to pursue monetary rewards

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a flowchart illustrating creating an account for a system and method for gamifying ride sharing;

FIG. 2 is a graphical representation of game piece selection and revenue generation for a system and method for gamifying ride sharing;

FIG. 3 is a pictorial representation of an example game board for a system and method for gamifying ride sharing;

FIG. 4 is a pictorial representation of zooming on a game board for a system and method for gamifying ride sharing;

FIG. 5 is a pictorial representation of viewing achievements and status for a system and method for gamifying ride sharing;

FIG. 6 is a pictorial representation of ranking for a system and method for gamifying ride sharing; and,

FIG. 7 is a pictorial representation of ranking for a system and method for gamifying ride sharing.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

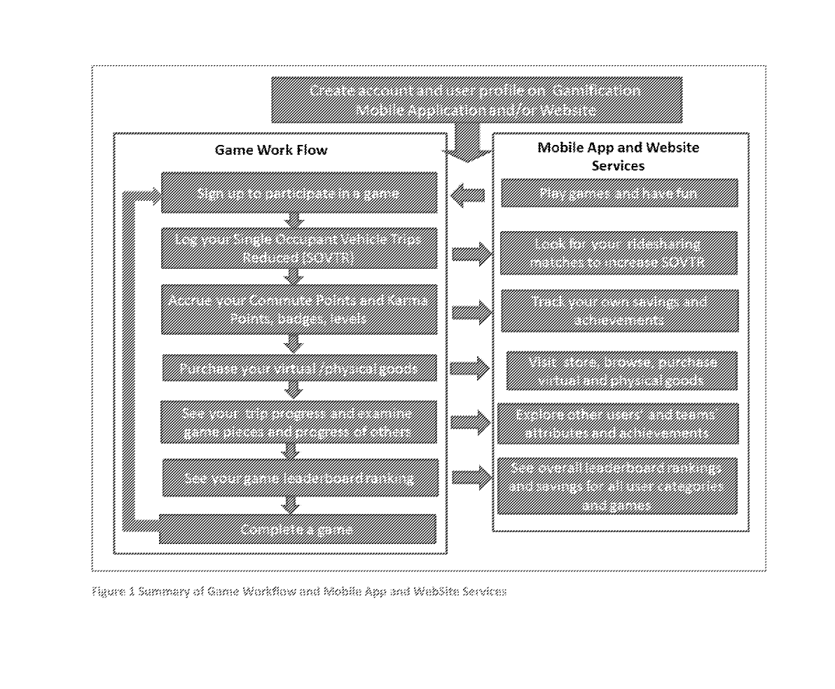

FIG. 1 is a flowchart illustrating creating an account for a system and method for gamifying ride sharing. Users create an account via the system and method and/or website and create their profile. The user then can enroll in games and log single occupant vehicle trip reductions (SOVTR) to make progress. They can access value added services such as ride matching to help them increase their number of SOVTRs. They can also track their progress and status in the game and in the overall gamification program.

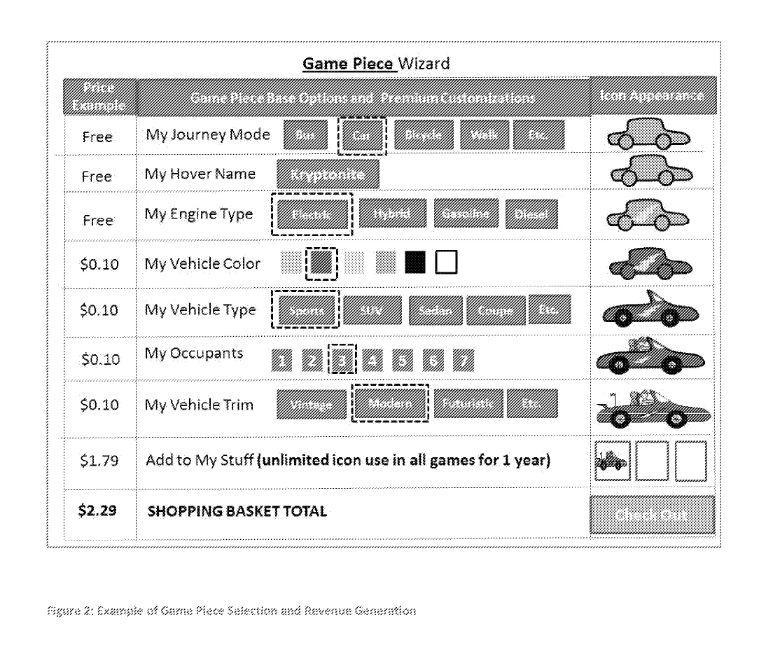

FIG. 2 is a graphical representation of game piece selection and revenue generation for a system and method for gamifying ride sharing.

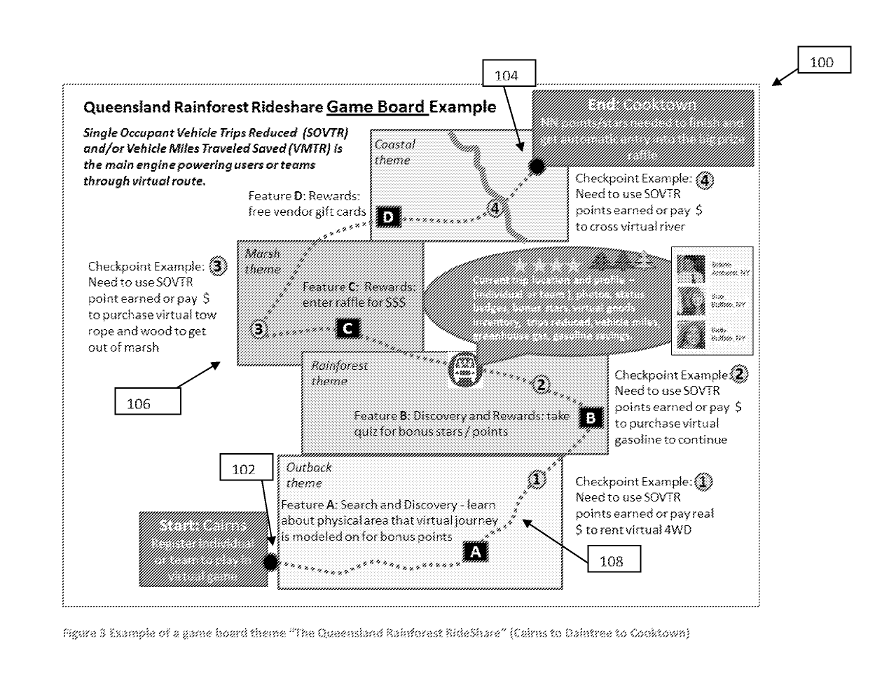

FIG. 3 is a pictorial representation of example game board 100 for a system and method for gamifying ride sharing.

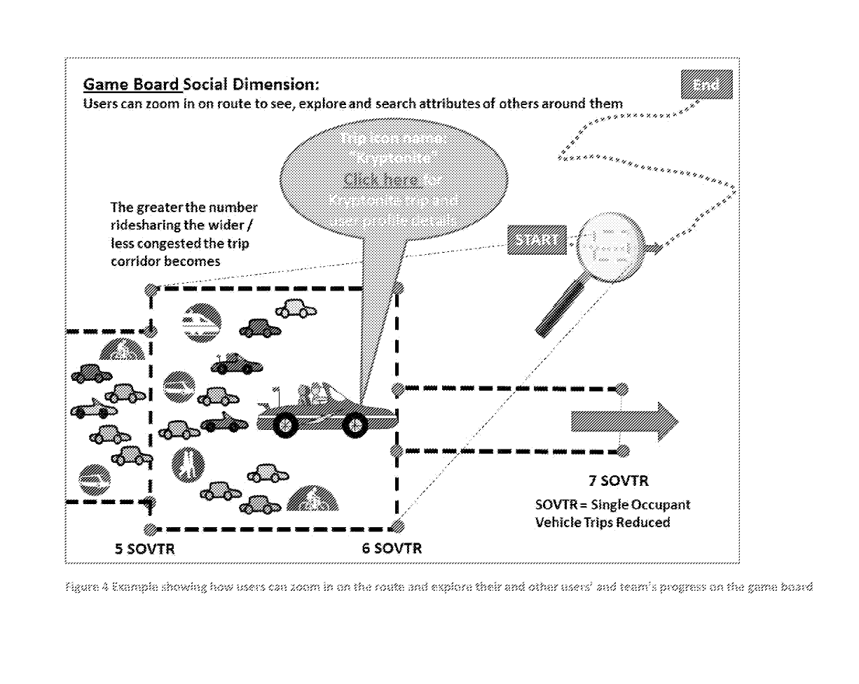

FIG. 4 is a pictorial representation of zooming on a game board for a system and method for gamifying ride sharing.

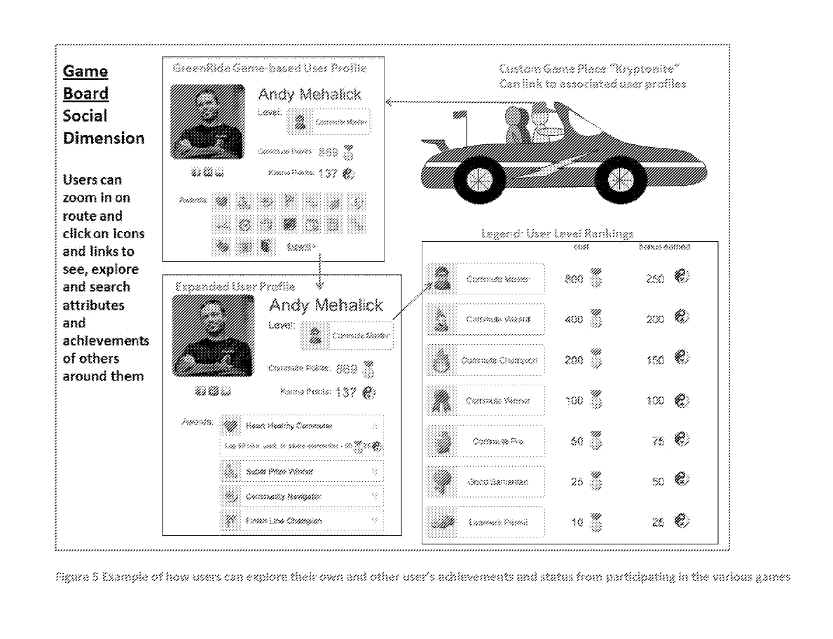

FIG. 5 is a pictorial representation of viewing achievements and status for a system and method for gamifying ride sharing.

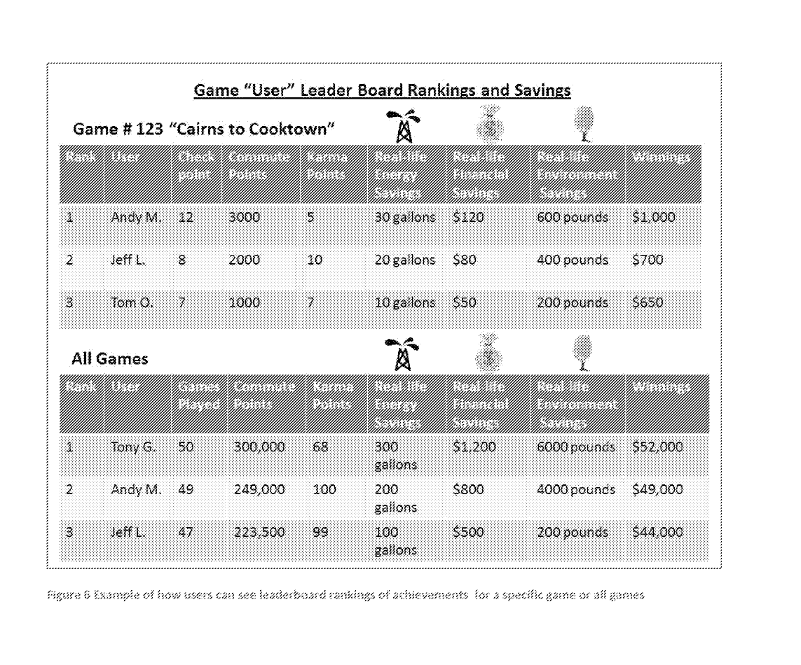

FIG. 6 is a pictorial representation of ranking for a system and method for gamifying ride sharing.

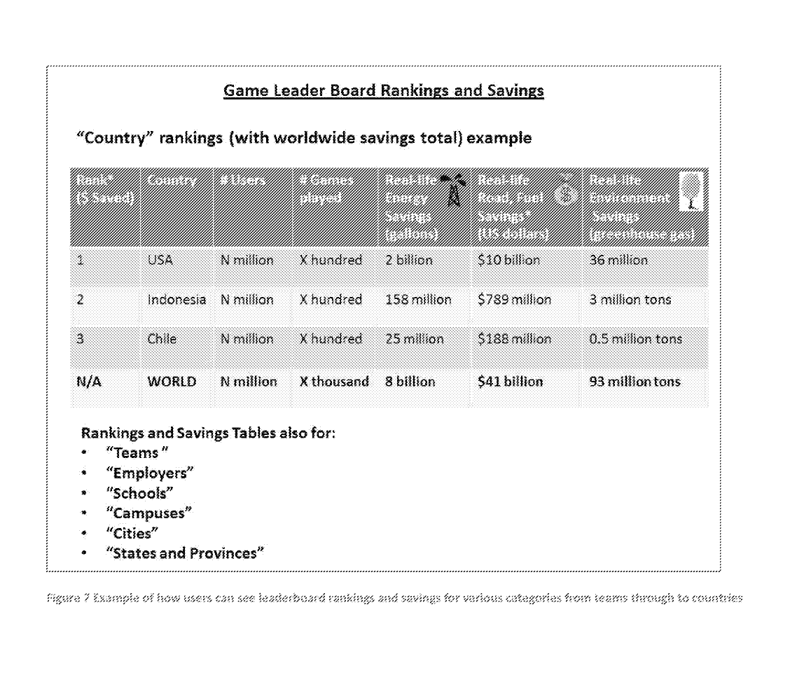

FIG. 7 is a pictorial representation of ranking for a system and method for gamifying ride sharing. The following should be viewed in light of FIGS. 2 through 7. In an example embodiment, game board 100 includes start point 102, end point 104, checkpoints 106, quizzes, surprise boxes, special offers, and other items to engage the user as they move along virtual route 108. Users are presented with aligned virtual or physical goods and services they might want to purchase (FIG. 2).

Game board landscapes can be themed, for example, geographically and/or sponsor driven, enabling users to be introduced to new things, places and people (FIG. 3). Users and teams can zoom in and out of a virtual route segment to see their overall progress and status as well as the status and progress statistics of others such as users and teams including small groups or employers and schools (FIGS. 4-6).

In an example embodiment, users can view a leaderboard summarizing the status and progress statistics for individuals, employers, schools, cities, and/or nations in a specific game or all games to date (FIGS. 6 and 7).

To proceed through a checkpoint an individual user or team (depending on the game or challenge) needs to reach a certain threshold of points or virtual goods or services that they have accumulated through playing the game. Game board virtual goods and services can be earned through logging SOVTRs or bought for the user's own enjoyment, or to accelerate their progress toward the checkpoints and ultimately along the virtual route to the journey endpoint (FIG. 2).

In an example embodiment, purchases use real currency through the mobile application or website. Virtual goods and services depreciate over time and may be expunged at the end of a game or carry over for a fee. Virtual possessions accumulated by the team can be retained for subsequent challenges noting depreciation impacts. Some virtual possessions may be exchanged or sold by team members to other teams but subject to a web or mobile application transfer fee.

In an example embodiment, winners are selected by raffle to level the playing field between those earning the virtual trip progress through logging SOVTRs and those buying progress through purchase of virtual goods and services. Raffles may be time limited or number of entrants limited, for example, selected from first 50 individuals to teams to accumulate total number of points and checkpoint clearances to finish or selected from all those who finished by conclusion of a certain time period. Raffle prizes may be an award or financial equivalent to undertake the virtual journey in the physical world, for example, flight to Cairns, bus to Daintree, guided 4 Wheel drive tour from Daintree to Cooktown and back, hotels and food or cash or donation (for example to carbonfund.org) if they want to be more sustainable.

In an example embodiment, a leveling system reflects the user's overall mastery of the application (FIG. 5). Levels are gained by obtaining experience points which, for example, are awarded for completing achievements or participating in events. For example, a new user can gain experience toward attaining particular goals, such as a Profiler achievement. In an example embodiment, the user attains the achievement by completing their user profile, including linking their account with an external social networking site.

In an example embodiment, an achievement system provides users with badges that appear on their user public profile (FIG. 5). Achievements help users level up, and also show off their success at certain activities. In an example embodiment, achievements come in three aspects:
1. One off achievements are gained by completing a certain task, for example, completing a user profile).
2. Multi-achievements are gained by completing a group of tasks, for example, taking part in all five types of commutes, or by carpooling 10 times in 10 days.
3. Time limited achievements are gained by completing a task within a certain time period. For example, “Weekly Commuter” is only active on a user profile if the user commuted at least 3 days of the previous week.

In an example embodiment, in addition to awarding experience points, achievements are awarded redemption points which can be used to buy real and virtual goods in the sites store.

In an example embodiment, “Karma points” are awarded when users provide good feedback on other users (FIG. 5). For example, if a user completes a short questionnaire about a recent commute, they receive five karma points, and the driver of the commute receives 1-10 points depending on how the other commuters respond in the survey. Karma points are redeemable for mystery boxes that contain a random number of redemption points or a redemption point power up that allows them to add a multiplier onto their earned redemption points for a number of days. Certain features on the site may not be accessible until a user has achieved a certain level, or a have earned a certain amount of Karma points

In an example embodiment, a system and method for gamifying ride sharing provide a monetization opportunity through several revenue streams:
1. Sponsors of a virtual game(s) and/or challenges.
2. Commissions for sales of physical goods and services that users can purchase through click through advertisements and objects embedded in the game.
3. Purchase and barter of virtual accessories and goods made available on the site that enable users to further their progress along a virtual journey (FIGS. 2 and 3)

In an example embodiment, games overlap in time and space. Users and teams can opt-in to multiple overlapping virtual journey games. In an example embodiment, the game board shows features of interest traversed by or proximal to the game board depicted route in the physical world (FIG. 3).

As an example, as shown in FIG. 1, the overall theme sponsors could be Queensland Tourism Authorities, Travel agencies or Travel clearing houses promoting that physical area for example or it could be a rainforest non-governmental organization or a commercial sponsor seeking recognition for promoting more sustainable travel (FIG. 3). Various visual displays, such as splash screens, videos, or photos introduce challenge participates to the journey theme and sponsors and advertisers.

In general, a challenge is open to both team and individual user categories either on a national, international or global basis depending on how many languages are integrated into the challenge. In an example embodiment, team rules are game dependent, but may have composition rules to enhance cultural and environmental understanding. For example, team composition could require four team members from four different continents using four different travel modes different from driving alone.

In an example embodiment, team members are responsible for forming their own team and cannot be on more than one team per challenge and cannot be on the same team for more than a limited number of challenges. In an example embodiment, being on the same team is defined as more that 50% of the users of that team being on a previous teams. In an example embodiment, team members must be recruited from participants in a particular group, for example, rideshare gamification mobile application, website, and/or other social networks provided they fill out their social profile on a gamification based web or mobile application based platform. In an example embodiment, a challenge is time restricted.

In general, individuals and teams log their single occupant vehicle trip reductions at periodic intervals, for example, at least weekly. In an example embodiment, users receive more SOVTR credits escalators for logging more frequently, for example, daily, to encourage frequent traffic. Individuals and team members can see how the SOVTRs they log are enabling them to move forward along the virtual route on a daily basis.

Credit levels can be absolute or adjusted based on level of change in mode shift activity, for example, one user could get less credit if they already carpool 5×/week compared to another user who carpools less, but increases the frequency of their carpooling as a result of a challenge.

In an example embodiment, participants must acquire sufficient SOVTRs and special accessories to clear checkpoints along the virtual route.

Special virtual goods or accessories can be bought or earned (FIG. 2). In an example embodiment, earning special virtual goods or accessories is through undertaking additional actions, for example, recycling, water conservation, energy conservation and self-report this over time. In an example embodiment, purchase of virtual goods provides users with a time advantage.

Advertisers can be commercial or retail business with click through advertisements of their vendor sales inventory (FIG. 3). Businesses providing goods or services related to themes or the general concepts compatible with the system and method for gamifying ride sharing, for example, outdoor activities, or environmental stewardship, may be particularly interested in advertising.

In an example embodiment, upon completion of a challenge, users and teams retain certain goods and/or accessories for a time limited depreciation period for credit for a subsequent challenge, or such items may be initialized at the end of the challenge (FIG. 2). In an example embodiment, at the end of a challenge users and teams are shown what they have accomplished through their real-world actions, for example as related to energy, economic, or environmental issues. The actions can further be related to sensitivity to and importance of the game theme, for example, rainforests, to underscore the cause driven aspect of ride sharing and how ride sharing benefits individuals, organizations, nations, and the planet (FIGS. 3, 5, and 6).

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based method for gamifying ride sharing, comprising:
storing computer readable instructions in at least one memory element of at least one computer; and,
executing, using at least one processor for the at least one computer, the computer readable instructions to:
accept a first input including a sign-up by a user for a game;
accept a second input including information regarding single occupant vehicle trips reduced by the user;
assign, according to the information:
a position of the user on a virtual board for the game;
a ranking of the user in the game; and,
at least one reward to the user; and,
transmit, for display, a graphical representation of the virtual board including the position of the user.
